(19) United States
(12) Patent Application Publication
(10) Pub. No.: US 2022/0237557 A1
(43) Pub. Date: Jul. 28, 2022

(54) SHIPMENT DELIVERY SYSTEM THAT OPTIMIZES ROUTES FOR PARCEL DELIVERY

(71) Applicant: Diego Munoz, Amityville, NY (US)

(72) Inventor: Diego Munoz, Amityville, NY (US)

(21) Appl. No.: 17/585,243

(22) Filed: Jan. 26, 2022

Related U.S. Application Data
(60) Provisional application No. 63/141,534, filed on Jan. 26, 2021.

(51) Int. Cl. G06Q 10/08; G06K 7/10; G01C 21/34

(52) U.S. Cl. CPC G06Q 10/0833; G01C 21/343; G06K 7/10445

(57) ABSTRACT

A shipment delivery system that optimizes routes and makes parcel delivery quick and efficient for delivery drivers.

### CROSS REFERENCE TO RELATED APPLICATIONS

This application claims priority to and benefit of U.S. Provisional Patent Application Ser. No. 63/141,534 dated Jan. 26, 2021.

### FIELD OF THE INVENTION

The present invention relates to a shipment delivery system that optimizes routes and makes parcel delivery quick and efficient for delivery drivers.

### BACKGROUND OF THE INVENTION

U.S. Pat. Nos. 7,049,963 and 7,164,359 relate to a networked RF tag for tracking freight. Method comprises attaching a low radio frequency detection tag to each object, tag having a tag antenna connected to a transceiver, a device for identifying tag, transceiver to emit identification signal, storing the shipping data, commingling objects in a warehouse or truck, and transmitting identification and shipping data from each tag to a data processor to provide tally of objects in the repository.

U.S. Pat. No. 7,474,217 relates to a system and method to track inventory using RFID tags, associated with products or groups of products and associated with first containers for products. RFID tags are associated with second container for the first containers. RFID tags broadcast respective identifications. Second RFID tags hash identities of first RFID tags within respective first containers.

U.S. Pat. No. 7,513,425 relates to article tracking system and method. RFID tag including memory and antenna associated with article and RFID tag reader at station has plural antennas for communicating with RFID tags and reading information which is communicated to a processor and stored in a database. The stored information may be utilized for tracking and managing the article, where the article may be located and its history obtained.

U.S. Pat. No. 7,593,712 relates to a system and method for using location information with wireless devices to execute an action. System includes a wireless device, location system, and a feature server. Location system generates location information pinpointing location of wireless device. Feature server uses location information to determine whether to execute an action in accordance with subscriber rules.

U.S. Pat. No. 7,603,299 relates to an automated receiving system for a distribution facility having at least one automated receiving door and at least one manual receiving door. System includes a scheduler and transport system. Scheduler receives electronic shipment data representative of incoming shipment based on electronic shipment data, and cause shipment to be directed to automated receiving door or manual receiving door based on unload score. Transport system receives each package from incoming shipment and transport each package within distribution facility.

U.S. Pat. No. 10,311,272 relates to a method and system for tracking delivery of objects that interact with a vehicle during operation of the vehicle, where the vehicle interacts with the specific objects at specific geographical positions. An identification sensor is attached to an object that is to be delivered to specific location. A record for the object is generated, the record including identification of the object, position of vehicle when interaction between object and vehicle occurs, and time of interaction. Record includes specific target location for delivery of object. Interactions include loading/unloading of object from vehicle. Alert is sent to driver when he approaches location adjacent to delivery location of vehicle.

US patent publication 20180194575 relates to a automatic truck loading and unloading system used for different freight sizes, trucks and trailers. System may inventory the parcels scheduled for delivery, identify dimensions of parcels, and plot a loading configuration that maximizes use of truck or trailer. Based on plotting, the system may direct automated guided vehicles to parcels scheduled for delivery. Automated guided vehicles may utilize information received from system to identify route from parcel's storage location in warehouse, to plotted position in truck or trailer.

US patent publication 20190043004 relates to a system and method and computer readable storage media for augmented reality loading to improve loading when types and order of items to be loaded is unknown. Server uses information regarding packages which have already been stored in storage area to generate a three dimensional map of where stored packages currently placed. Upon receiving information indicating subsequent package is going to be stored, server can identify best place to store package in storage area, then communicate storage location to augmented reality device worn by worker. Worker has visual indication showing where and how to place subsequent package.

The main hurdle facing delivery drivers is having to plan efficient routes, search their vehicles for their parcels, and deliver them on a timely basis each day. When elements like bad weather, lack of light or a larger volume of parcels are factored in, delivery drivers have their hands full trying to hit each drop off destination in a timely manner

With regards to USPS, UPS, FedEx and DHL subscribes to containers arrive at a warehouse full of packages. Once the packages are brought into the warehouse, they are organized by zip codes, and each zip code gets assigned to a loader. The loader is responsible for scanning, loading and organizing packages into the cargo-van for the driver. The process of scanning, loading and organizing is time consuming, and usually takes 1.5-2 hours roughly 400 packages for the driver. Process typically occurs between 5:00 AM to 9:00 AM. Driver arrives at warehouse by 9:00 AM. Loader shows driver how packages were set up for the day, i.e., next-day deliveries placed in front of van, regular deliveries organized in cargo area of van. The driver prioritizes all next-day deliveries and therefore are to be delivered before 10:30 AM. Once the first set of deliveries is complete, the driver pulls over to organize the remaining regular deliveries for the day. While loader organizes packages to best of their ability, driver is person who knows how the rest of packages and corresponding routes must be handled. Process requires re-organization of packages which takes up time from driver.

For Amazon, T-Force and Lasership, there are no loaders. The driver acts alone in picking, scanning and organizing their own packages. Some warehouses have workers pick and scan packages, but the driver is responsible for loading and organizing their route for the working day. Each driver has a unique way for configuring their routes. Some drivers organize their packages by street name or numbers and some use physical markers to mark packages and place them in strategic places in their van.

### SUMMARY OF THE INVENTION

The present invention relates to a shipment delivery system that optimizes routes and makes parcel delivery quick and efficient for delivery drivers.

The present invention combines the ease of route planning with quick indicators to where the packages are located. It is an object of the present invention to provide an LED signal to ensure that the package corresponds to the correct drop off location.

It is an object of the present invention to incorporate the system of the present invention to a shipping companies current route planner. It is an object of the present invention for the system to allow the loader or driver to know the exact number of packages that are to be delivered that day, as well as the sequence of package deliveries. It is an object of the present invention for the system to assist drivers in the field so that they just have to follow the route sequence to reach each delivery destination, provided by the GPS integrated into the system. It is an object of the present invention for the drivers to find their target destination, park and search for a package with a quick and bright signal.

It is an object of the present invention for the system to obviate misreading package labels. It is an object of the present invention for the system to obviate the need to reorganize the cargo vans and have to search for the right package.

It is an object of the present invention for the system to systematically group parcels by convenient delivery routes. Once a package's drop off destination has been reached via the system's GPS, the driver will be able to use the system to transmit a signal to a small electronic/sensory device connected to the corresponding parcel. That signal from the system will emit an LED light sensor to aid the driver in scanning their vehicle to retrieve the package, reducing the time spent searching for the parcel.

It is an object of the present invention for the system to be able to identify packages with large amounts of parcels in the vehicle. It is an object of the present invention to prevent drivers from misreading labels or straining to read labels. It is an object of the present invention for the system to prevent drivers from taking a long time to find parcels as they deal with traffic in high density areas. It is an object of the present invention for the system to assist drivers in finding packages due to packages shifting around due to motion of the vehicle.

It is an object of the present invention for the system to assist the driver in searching for parcels, effectively retrieving them and delivering them on time.

Although each delivery system has their own form of a route planner it is an object of the present invention for the system and the sensory technology of the present invention to be integrated into each of their systems.

The present invention relates to affixing a small sensory device to each package during the sorting process. It is an object of the present invention for this to be done by a delivery loader. The loader would then scan each package's sensor that would then sync up the package to its delivery details within the system's route planning and GPS services. Once the loader is done with the scanning process, the system's route planner configures the sequence of the entire route in ordered delivery stops. Because the loader has access to the system and the sensory light device, a loader can highlight all next-day delivery parcels and be able to arrange them accordingly in the van. The process continues with all package categories until the vehicle is loaded up. The loader only has to affix the physical sensor to each package, scan and load. The driver's only job is to follow the curated route plan and respond to the sensor's signal per package.

It is an object of the present invention to have an application that works in conjunction with a mobile device to track packages being loaded into personal vehicles.

It is an object of the present invention for the package to have a hardware component, a device that attaches to a singular package, attached by a mechanism to a package, which syncs to an application.

It is an object of the present invention to have a software component, application using web based technologies, to send a signal to this hardware to make it easier to find target package within a vehicle with the intent to streamline the visual or audible motivation of where it is located in the vehicle.

It is an object of the present invention to provide a scalable system to send individual signals to each package as they are delivered. It is in object of the present invention of the signal to be audible, visual, or both indications to better find that package at delivery.

It is an object of the present invention to have 2D barcodes with varying size and built-in visual redundancy used to identify the tracking device.

It is an object of the present invention to perform integration with at least the OCR engine based on actual photos taken of boxes/labels.

It is an object of the present invention to evaluate accuracy of the OCR engines and the ability to send an address and tracking device barcode.

It is an object of the present invention to establish wire frames of the mobile application.

It is an object of the present invention to develop a mobile application and a picture function.

It is an object of the present invention to integrate selected OCR engine into a mobile application to associate the tracking device and shipping address.

It is an object of the present invention of the present invention to provide an Android APK build of the mobile application.

It is an object of the present invention to use a tracker pairing in iOS (iphone).

It is an object of the present invention to have application Bluetooth integration with a hardware device for light and sound triggers.

It is an object of the present invention to provide integration with a driving direction provider. It is an object of the present invention for the driving directions provider to be Google maps.

It is an object of the present invention for the driving directions to be used with iOS or Android.

It is an object of the present invention for the tracking device to have a Bluetooth trigger. It is an object of the present invention for the Bluetooth trigger to be used with iOS and Android.

It is an object of the present invention for the mobile application to be deployed to app stores and available for driver use.

### DETAILED DESCRIPTION

The present invention relates to a shipment delivery system that optimizes routes and makes parcel delivery quick and efficient for delivery drivers. The invention combines the ease of route planning with quick indicators to where the packages are located. In an embodiment, the invention provides an LED signal to ensure that the package corresponds to the correct drop off location.

In an embodiment the system provides the exact number of packages that are to be delivered that day, as well as the sequence of package deliveries. The invention assists drivers in the field so that they just have to follow the route sequence to reach each delivery destination, provided by the GPS integrated into the system. The invention assists drivers in finding their target destination, and the correct package. In a preferred embodiment, a bright signal guides the driver to their package.

The system of the present invention obviates misreading package labels and the need to reorganize the cargo vans and have to search for the right package.

In an embodiment, the system systematically groups parcels by convenient delivery routes. Once a package's drop off destination has been reached via the system's GPS, the driver uses the system to transmit a signal to a small electronic/sensory device connected to the corresponding parcel. That signal from the system emits an LED light sensor to aid the driver in scanning their vehicle to retrieve the package, reducing the time spent searching for the parcel.

In an embodiment, the system assists drivers in finding packages due to packages shifting around due to motion of the vehicle.

In an embodiment, a small sensory device is affixed to each package during the sorting process. In a preferred embodiment, this is done by a delivery loader. The loader scans each package's sensor and sync up the package to its delivery details within the system's route planning and GPS services. Once the loader is done with the scanning process, the system's route planner configures the sequence of the entire route in ordered delivery stops. Because the loader has access to the system and the sensory light device, a loader can highlight all next-day delivery parcels and be able to arrange them accordingly in the vehicle. The process continues with all package categories until the vehicle is loaded up. The loader only has to affix the physical sensor to each package, scan and load. The driver's only job is to follow the curated route plan and respond to the sensor's signal per package.

The present invention provides an application that works in conjunction with a mobile device to track packages being loaded into personal vehicles.

The present invention provides a hardware component, a device that attaches to a singular package, attached by a mechanism to a package, which syncs to an application.

The present invention uses a software component, application using web based technologies, to send a signal to the hardware to make it easier to find the target package within a vehicle to streamline the visual or audible motivation of where it is located in the vehicle.

The present invention provides a scalable system to send individual signals to each package as they are delivered. In an embodiment, the signal is audible, visual, or both indications to better find that package at delivery.

In an embodiment, the system uses 2D barcodes with varying size and built-in visual redundancy used to identify the tracking device.

In an embodiment, the system performs integration with at least the OCR engine based on actual photos taken of boxes/labels. In an embodiment, the system evaluates accuracy of the OCR engines and the ability to send an address and tracking device barcode. In an embodiment, the system establishes wire frames of the mobile application. In an embodiment, the system uses a mobile application and a picture function.

In an embodiment, the system integrates selected OCR engines into a mobile application to associate the tracking device and shipping address. In an embodiment, the system provides an Android APK build of the mobile application. In an embodiment, the system uses a tracker pairing in iOS (iphone).

In an embodiment, the system uses an application Bluetooth integration with a hardware device for light and sound triggers. In an embodiment, the system provides integration with a driving direction provider. In a preferred embodiment the driving direction provider is Google maps. In an embodiment, the driving directions are used with iOS or Android. In an embodiment, the tracking device has a Bluetooth trigger. In a preferred embodiment, the Bluetooth trigger is used with iOS and Android.

1. A shipment delivery system comprising:
a sensory device affixed to each package for locating each package;
software that provide route planning;
GPS integrated into said system;
each packages sensory device are synced up to said package to its delivery details within said systems' route planning GPS services;
said systems route planner configures sequence of entire route in ordered delivery stops.

2. The system of claim 1 further comprising an LED signal to ensure each package corresponds to the correct drop off location.

3. The system of claim 1 wherein said system provides exact number of packages that are to be delivered that day, as well as sequence of package deliveries.

4. The system of claim 1 wherein said system assists drivers in finding their target destination, and the correct package.

5. The system of claim 1 wherein said sensory device comprises a bright signal located on each package.

6. The system of claim 1 wherein said system obviates misreading package labels and need to reorganize vehicle and search for right package.

7. A method for delivering packages efficiently comprising:
systematically grouping parcels by convenient delivery routes;
transmitting a signal to an electronic/sensory device connected to a corresponding parcel when it is ready to be delivered;
emitting an LED light sensor to aid a driver in scanning said driver's vehicle to retrieve said package;
delivering said package to a destination provided to said driver via GPS.

8. The method of claim 7 further comprising finding packages due to shifting around of said packages due to motion of said vehicle.

9. The method of claim 7 wherein a driver only has to affix a physical sensor to each package, scan and load.

10. The system of claim 1 wherein said system comprises a software component, application using web based technologies, to send a signal to hardware to said package within a vehicle to streamline visual or audible motivation of where it is located in said vehicle.

11. The system of claim 1 wherein said system performs integration with at least an OCR engine based on actual photos taken of boxes/labels.

12. The system of claim 11 wherein said system evaluates accuracy of OCR engines and ability to send an address and tracking device barcode.

13. The system of claim 1 wherein said system integrates selected OCR engines into a mobile application to associate tracking device and shipping address.

14. The system of claim 1 wherein said system provides an Android APK build of said mobile application.

15. The system of claim 1 further comprising a tracker pairing in iOS (iphone).

16. The system of claim 1 further comprising Bluetooth integration with a hardware device for light and sound triggers.
